(19) United States
(12) Patent Application Publication
(10) Pub. No.: US 2008/0141514 A1
(43) Pub. Date: Jun. 19, 2008

(54) Casting finishing device

(75) Inventor: Kaoru Ichihashi, Higashiomi-Shi (JP)

Correspondence Address: VENABLE LLP, P.O. BOX 34385, WASHINGTON, DC, 20043-9998, US

(73) Assignee: Shigayamashita Co., Ltd., Higashiomi-Shi (JP)

(21) Appl. No.: 11/984,500

(22) Filed: Nov. 19, 2007

(30) Foreign Application Priority Data
Dec. 14, 2006 (JP) 2006-336936

(51) Int. Cl. B23P 23/00

(52) U.S. Cl. 29/33 R

(57) ABSTRACT

[Problem] Provision of a finishing device which is capable of performing teaching with ease and which has an articulated structure having increased mechanical strengths of its joints.

[Means to Solve the Problem] In a finishing device for finishing a casting W having a complicated shape by removing undesired matter which is deposited or formed on the casting, such as casting sand, irregularities derived from a pouring gate and a feeder head, burrs and the like by means of a numerical control (NC) mechanism for an articulated structure, the device comprises: a jig unit A for positioning of the casting W to be finished in a position that facilitates machining; a tool unit B for applying necessary machining to the positioned casting W by operation of a tool; and a control unit C for comprehensively interpolation-controlling the jig unit A and the tool unit B.

### TECHNICAL FIELD

The present invention relates to a casting finishing device for finishing various castings (works) having complicated shapes by removing undesired matter deposited or formed on the works in preparation of the works by casting of aluminum, iron or the like, such as casting sand, irregularities derived from pouring gates and feeder heads, burrs and the like. In particular, it relates to a casting finishing device for finishing a casting having a complicated shape, which has increased mechanical strengths of joint (articulated) shafts of its articulated structure, i.e., multijoint structure and which is so constructed as to be compact.

Various auto parts, for example, a cylinder head, a cylinder block, an intake manifold and the like are prepared by casting aluminum, iron or the like thereinto. The castings (works) obtained by the preparation have complicated shapes, and thereon, undesired matter such as casting sand, irregularities derived from a pouring gate and a feeder head, burrs and the like are deposited or formed. Accordingly, it is necessary that the undesired matter be removed from the works to effect finishing.

In general, many of castings have complicated shapes. Accordingly, in finishing of such castings, a machine tool is required to perform complicated motions, and thus numerically controlled (NC) machining is required.

As a general purpose casting finishing device, a 6-axial vertical articulated robot has heretofore been used widely. Since positions and postures of a 6-axial vertical articulated robot can be set freely, necessary finishing can be applied to a casting as a work by means of a machine tool disposed on a fixed side with the work held by the robot.

Alternatively, a machine tool and a casting (work) may be held by the robot and the fixed side, respectively. In casting finishing steps, a 6-axial vertical articulated robot of which positions and postures can arbitrarily set is very effective particularly in a burr removing step, because burrs are formed on various portions of the surface of the work in random directions.

On the casting (work), however, casting sand, burrs, irregularity of a pouring gate for casting and the like are deposited or formed, which have irregularities in shape. Accordingly, when the casting (work) is machined or transferred by a robot, an abnormal burr of the casting (work) or the like frequently interferes with a constituent of the machine tool or jig.

In such a case, since an ordinary 6-axial vertical articulated robot has low joint mechanical strengths, dislocation of an joint (articulated) shaft or joint (articulated) shafts is likely to occur to cause a long time stop of a production line. This has prevented operation rate of the production line from being increased. Further, backlashes in reduction gears used in the joints lower machining accuracy.

In general, when an articulated mechanism having 6-axial degree of freedom is used as a numerically controlled (NC) mechanism, the mechanism is capable of performing any (arbitrary) motions and is thus suitable for finishing of a casting having a complicated shape. However, in a case where the mechanism is composed of a single unit, the mechanism has a large size unless mechanical strengths of joints of 4th, 5th and 6th shafts are set to be low, resulting in the large-sized device.

As a means to increase mechanical strengths of joints, it suffices for the purpose that a large reduction gear be used in each of the joints to impart strengths capable of overcoming forces exerted on the joints at the time of interference to the joints. However, if such necessary mechanical strengths are imparted to the joints, each of the joints has a large size and thus the device has a very large size and an increased weight. This prevents rapid movement of the device, and accordingly, a time period for finishing is prolonged. In consequence, the device takes a large installation space and has poor productivity, and cost thereof is high. Further, backlashes in the reduction gears used in the joints lower machining accuracy.

As a device which uses a large reduction gear in each of joints to impart mechanical strengths capable of overcoming forces exerted on the joints at a time of interference to the joints, such a device has been provided that a jig section and a tool section are separately disposed. However, since no connective interpolation control is performed between the jig section and the tool section, it is difficult to teach a program for machining a work to the device.

Patent Document 1: Japanese Unexamined Patent Publication No. Hei 7 (1995)-204952

Patent Document 2: Japanese Registered Utility Model Publication No. 3085828

### DISCLOSURE OF INVENTION

### Problem to be Solved by the Invention

It is, therefore, a problem to be solved by the invention to provide, for finishing a casting having complicated shape by removing undesired matter deposited or formed on the casting, such as casting sand, irregularities derived from a pouring gate and a feeder head, burrs and the like by means of a numerical control (NC) mechanism for an articulated mechanism (structure), a device for finishing a casting having a complicated shape of which an articulated structure is divided into a jig unit and a tool unit that are concurrently interpolation-controlled by a single control unit to thereby increase mechanical strengths of joint (articulated) shafts of the articulated structure, and accordingly, which is capable of solving the drawbacks inherent in the above-described known techniques.

### Means to Solve the Problem

To realize a compact size of a casting finishing device even if it uses reduction gears to which necessary strengths are imparted, it is characterized in that its 8-axial vertical articulated structure is divided into two units, i.e., a combination of a jig unit having a multiaxial articulated structure for positioning a work in necessary position and posture and a tool unit having a multiaxial articulated structure for moving a tool in a course necessary for machining the work, and both of the jig unit and the tool unit are controlled by a single control unit to enable interpolation movement of each of the units. Further, backlashes in the reduction gears used in the joints are eliminated to thereby improve machining accuracy.

### EFFECT OF THE INVENTION

The device of the present invention which has the above-described structure is such that its articulated structure is divided into the jig unit and the tool unit which are disposed as separate units and interpolation-controlled by the control unit. Accordingly, mechanical strengths of the joint shafts of the articulated structure are increased, and the device is compact and capable of performing teaching with ease, and machining accuracy is improved.

### BEST MODE FOR CARRYING OUT THE INVENTION

In the following, the present invention will be described in detail with reference to the accompanying drawings.

In FIG. 1, W represents a casting (work) to be machined, and specifically, it is one of various auto parts, for example, a cylinder head, a cylinder block, an intake manifold or the like. In general, such a work is prepared by casting aluminum or iron thereinto.

The casting (work) obtained by the preparation is likely to have a complicated shape, and undesired matter such as casting sand, irregularities derived from a pouring gate and a feeder head, burrs and the like is deposited or formed thereon. Accordingly, the undesired matter is removed from the work W by means of a numerical control (NC) mechanism of for an articulated structure, i.e., a multijoint structure to effect finishing.

This articulated structure is 8-axial. In other words, the articulated structure has a pivot shaft 1 which pivots in the directions shown by the double-headed arrow, a swinging shaft 2 which swings in the directions shown by the double-headed arrow, a swinging shaft 3 which swings in the directions shown by the double-headed arrow, a swinging shaft 4 which swings in the directions shown by the double-headed arrow, a pivot shaft 5 which pivots in the directions shown by the double-headed arrow, a pivot shaft 6 which pivots in the directions shown by the double-headed arrow, a swinging shaft 7 which swings in the directions shown by the double-headed arrow, and a moving shaft 8 which moves in the directions shown by the double-headed arrow.

The articulated structure comprises a jig unit A and a tool unit B each of which has a selectable (variable) number of shafts according to machining to be effected. The feature of the present invention resides in that the device of the present invention comprises the jig unit A for clamping a casting (work) W with a work clamping jig 9 in a posture which facilitates machining by pivoting the pivot shaft 1, swinging the swinging shafts 2, 3 and 4, and pivoting the pivot shaft 5, and the tool unit B for moving the work W clamped by the work clamping jig 9 by swinging the swinging shafts 6 and 7 and moving the moving shaft 8 to effect intended machining by operation of a tool 10 such as an end mill, a chip saw, a chipper or the like, and that these jig unit A and tool unit B are separately disposed as separate units and the jig unit A and the tool unit B are controlled by a control unit C for concurrently interpolation-controlling the jig unit A and the tool unit B.

FIG. 2 is a flow sheet of operation of the control unit C which controls operations of the jig unit A and the tool unit B. In the manner as shown in FIG. 2, driving motors X1, X2, X3 and X4 of the jig unit A and driving motors Y1, Y2, Y3 and Y4 of the tool unit B are controlled.

FIG. 3 shows the pivot shaft 1 as a typical joint shaft (articulated shaft ?) of a backlash eliminating unit 11 for a reduction gear. The reduction gear constituting the joint shaft (articulated shaft) has a backlash therein, and thus a rotational angular position of a servo motor 12 cannot be reproduced accurately. An angle of an output shaft is changed in an angular amount corresponding to the backlash. Accordingly, accuracy of the angular position is lowered.

To eliminate the backlash, a torque transmission gear 13 is attached to the output shaft, and a pinion 16 is attached to a tip of a torque actuator 15 on the fixed side relative to the output shaft. A pre-load is applied to the reduction gear from the pinion 16 through the torque transmission gear attached to the output shaft 14 to thereby eliminate the backlash which the reduction gear has. In consequence, lowering of the accuracy due to the backlash can be prevented, and thus machining accuracy is improved. In the embodiment shown in FIG. 1, a backlash eliminating unit 11 is attached to each of the shafts 1, 3, 4, 5 and 7.

### INDUSTRIAL APPLICABILITY

The device of the present invention is capable of performing teachings with ease by virtue of increased mechanical strengths of the joints in its articulated structure, i.e., multijoint structure and its capability of interpolation-moving, and it is compact. Accordingly, the device is applicable to finishing of a work A (W?) having a complicated shape. Further, backlashes in the reduction gears used in the joint (articulated) shafts are eliminated to thereby enable machining accuracy to be improved. As described above, the casting finishing device of the present invention has high industrial applicability.

### BRIEF DESCRIPTION OF DRAWINGS

FIG. 1 is a perspective view of an embodiment of the finishing device according to the present invention.

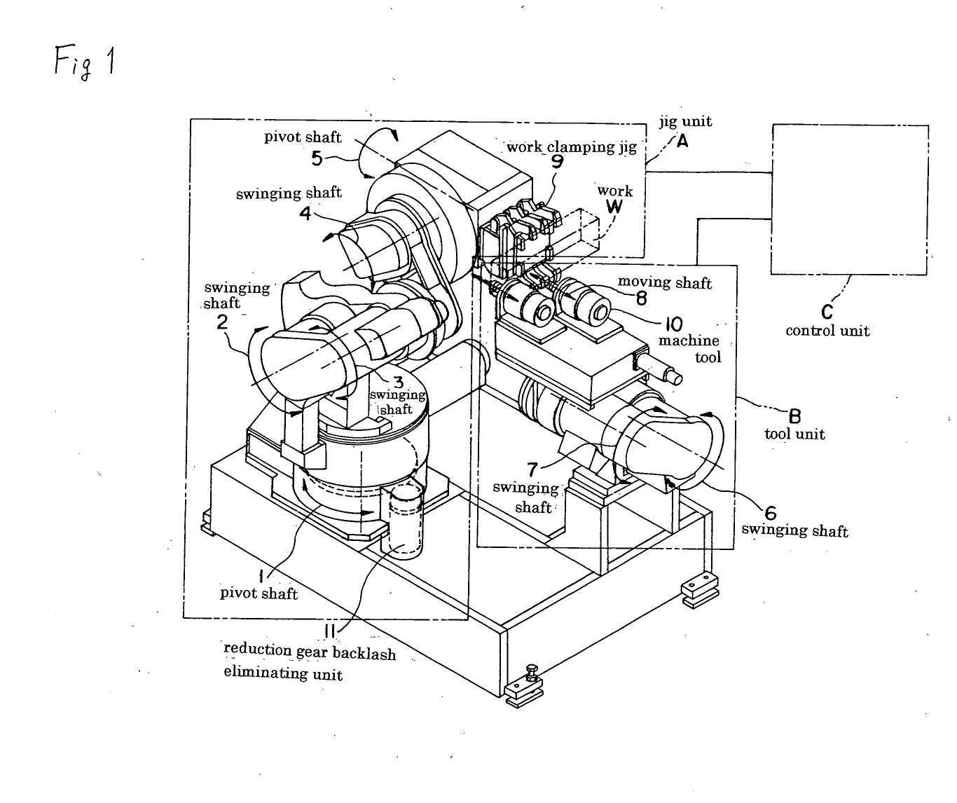

FIG. 2 is a block diagram of the finishing device according to the present invention.

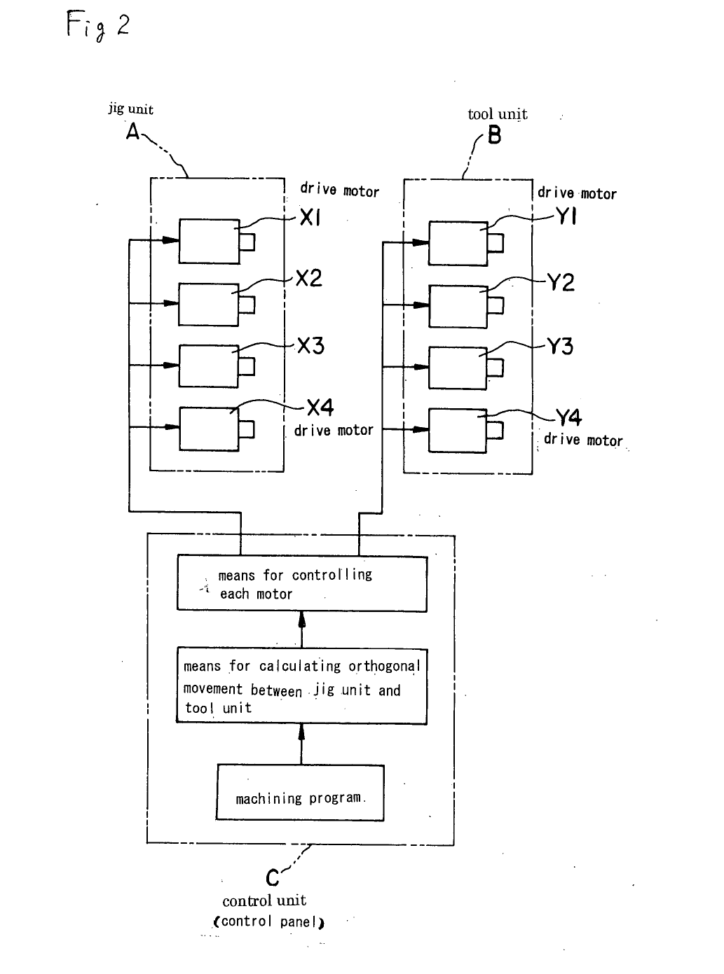

FIG. 3 is a schematic view of the backlash eliminating unit of the reduction gear for the joint (articulated) shaft according to the present invention.

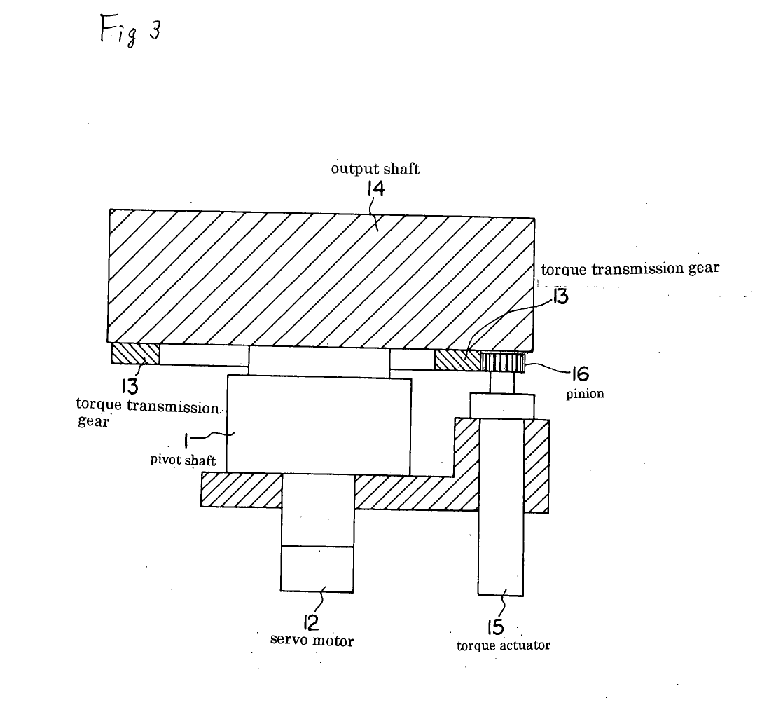

### NOTE ON REFERENCE DESIGNATORS

W: work
1: pivot shaft
2: swinging shaft
3: swinging shaft
4: swinging shaft
5: pivot shaft
6: swinging shaft
7: swinging shaft
8: moving shaft
9: work clamping jig
10: machine tool
11: reduction gear backlash eliminating unit
12: servo motor
13: torque transmission gear
14: output shaft
15: torque actuator
16: pinion
A: jig unit
B: tool unit
C: control unit

1. A casting finishing device comprising:
a jig unit having a multiaxial articulated structure having its end provided with a jig for positioning a work;
a tool unit having a multiaxial articulated structure having its end provided with a tool necessary for finishing the casting (work); and
a control unit for interpolation-controlling said two units.

2. The casting finishing device according to claim 1, wherein a part or all of the joint (articulated) shafts are each provided with a reduction gear backlash eliminating mechanism.
